(19) United States
(12) Patent Application Publication
(10) Pub. No.: US 2015/0163303 A1
(43) Pub. Date: Jun. 11, 2015

(54) Customizable Cloud or Distributed System Location

(71) Applicant: Sarah M. Banas, Chicago, IL (US)

(72) Inventor: Sarah M. Banas, Chicago, IL (US)

(73) Assignee: Sarah M. Banas, Chicago, IL (US)

(21) Appl. No.: 14/099,967

(22) Filed: Dec. 8, 2013

(51) Int. Cl. H04L 29/08

(52) U.S. Cl. CPC H04L 67/1097

(57) ABSTRACT

One embodiment of creating, managing, or accessing a cloud storage system where users choose the hardware location or locations for the cloud system deployment and management that can be used for backup, storage, software deployment, or other user needs. Other embodiments are described and shown.

### CROSS-REFERENCE TO RELATED APPLICATIONS

Not applicable

### FEDERALLY SPONSORED RESEARCH

Not applicable

### SEQUENCE LISTING

Not applicable

### BACKGROUND OF THE INVENTION

This invention generally relates to cloud computing or distributed systems, specifically the ability to create and access a user or users' cloud storage system by allowing the user to choose the location or locations of the cloud storage instances.

### BACKGROUND OF THE INVENTION

### Prior Art

The following is tabulation on some prior art that presently appears relevant:

U.S. Patents

| Patent Number | Issue Date | Patentee |
|---|---|---|
| 8,566,428 | 2013 Oct. 22 | Wee; Sewook |
| 8,572,549 | 2013 Sep. 3 | Cidon; Asif |
| 8,572,602 | 2013 Oct. 29 | Colton, et al. |
| 8,578,205 | 2013 Nov. 5 | Leggette, et al. |

Originally, the basis of cloud computing was created for flexibility, cost reduction, and increased storage. While true that deploying a cloud instance has become easy and almost instantaneous, the cloud has come at a price: security, support, and inflexibility. No one really knows where the data is truly located, except that the data “is in the cloud.” What that means is that in one minute that data can be located across the globe in a foreign country whose security and data infrastructure may be severely lacking. In the next minute, that data may be in a building right next door to the user. No one knows, as it is entirely dependent on the company providing the cloud instance where that company's servers are located. Often times, the locations of said servers are not disclosed.

Several types of cloud storage systems have been proposed—for example, the U.S. Pat. No. 8,566,428 (2013, Wee), U.S. Pat. No. 8,572,549 (2013, Cidon), U.S. Pat. No. 8,572,602 (2013, Colton), and U.S. Pat. No. 8,578,205 (2013, Legette) all propose cloud storage systems with at least one cloud provider and at least one master server. However, none of the patents address the security aspect of housing the data in a cloud storage system at a cloud provider, nor do the patents propose infrastructures without a main or master server. Previous proposed cloud systems suffer from a number of disadvantages:

(a) No way to create a private or public cloud with reliable security.

(b) No cloud provider knows where the cloud is located, only that it is dispersed among a multitude of servers among multitudes of locations, of which many or all locations not have high security implementation. As such, users are not aware of the location of said servers, where data storage laws could differ from state to state.

(c) In U.S. Pat. No. 8,572,549 (Cidon), the method requires a master cloud server to store a user's data, thereby locking a user to a main server that, if is disrupted, can lose all of the user's data.

(d) U.S. Pat. No. 8,572,602 (Colton) requires the configuration of a remote cloud manager to work with any web application with at least one cloud provider. Clouds cannot be deployed internally, and the cloud manager cannot be deployed locally with remote access.

Similarly, U.S. Pat. No. 8,578,205 (Leggette, et al) describes a method of data storage requests with data reliability indications Like previous patents, it does not deal with security or infrastructure.

### SUMMARY

In accordance with one embodiment of a cloud storage system, the system can be either private or publically deployed, wherein the user or group of users choose the hardware geographic location or have the system choose said geographic location relative to the user's geographic location, and are not limited to a single master hardware or server deployment.

### Advantages

Accordingly several advantages of one or more aspects are as follows: the user or users are able to selectively choose what geographic area the hardware will be deployed and maintained in, as best suits his or her needs and requirements for a temporary or permanent need, such as for backups, general storage, email handling, and others. As such, security risks are at a minimal as the user knows exactly where his or her data is located. These and other advantages of one or more aspects will be apparent from a consideration of the drawings and ensuing description.

### DRAWINGS

### Figures

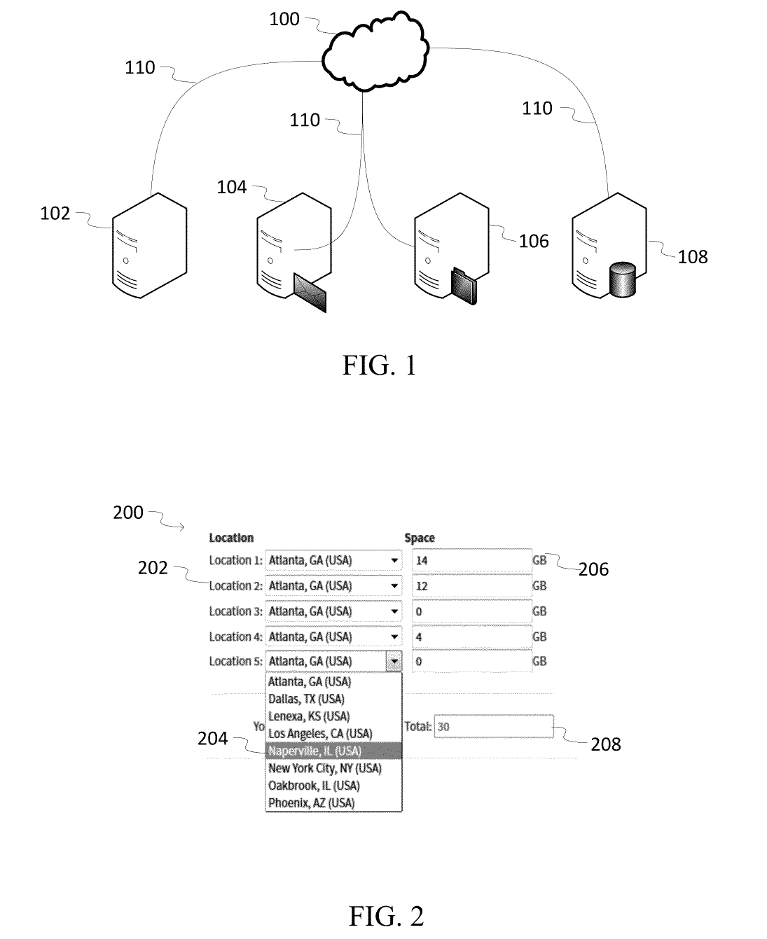

FIG. 1 refers to a distributed cloud system with various server applications.

FIG. 2 shows a sample cloud configuration.

DRAWINGS - REFERENCE NUMERALS

| | |
|---|---|
| 100 | Cloud |
| 102 | Basic server |
| 104 | Email server |
| 106 | File server |
| 108 | Database server |
| 110 | Server connected to cloud |
| 200 | Sample cloud configuration |
| 202 | Cloud location choices |
| 204 | Selection of cloud choices |
| 206 | Amount of space (GB) user defines |
| 208 | Total amount of space (GB) |

### DETAILED DESCRIPTION

Referring to FIG. 1, which shows a cloud or distributed system with sample attached servers: a basic server 102, an email server 104, a file server 106, and a database server 108. Each server can be connected 110 to create a cloud system 100. Unlike other cloud systems, each server has been chosen by the user, and if required, modified to fit the user's requirements. For example, the user has a general server 102 that he or she uses for application deployment. Another server 104 is used for emails and email management, retention. A file server 106 is included for file management; and 108 database server is used for strictly database storage. However, due to the system scalability, each server can be repartitioned or modified. That is, a file server 106 can be another email server 104, or another database server 108. The cloud itself was created by the user, with each server's location chosen by said user, rather than being randomly chosen by the cloud provider.

Referring now to FIG. 2, it is describes a sample server configuration 200. A user can choose at least 1 server, with the ability to specify the location 202 of each individual server at available. Locations 204 are stored within the main database, and are presented in a drop-down in this case. Each server can also have as much initial space allocated 206 as the user requires. The total amount of space 208 is shown and then allocated for the user.

### CONCLUSION, RAMIFICATIONS, AND SCOPE

Thus the reader will see that at least one embodiment of the cloud system provides a higher level of security, trust, and stability for users who use public or private clouds.

While the above description contains many specificities, these should not be construed as limitations on the scope of any embodiment, but as exemplifications of various embodiments thereof. Many other ramifications and variations are possible within the teachings of the various embodiments. Furthermore, the cloud or distributed system has the additional advantages in that:
The system can be deployed internally for a company, or externally to create public instances;
The system can deploy internal public clouds, external private clouds, or any combination thereof;
It can show data usage and statistics for variety of servers, locations, for management, interaction, and integration;
Specific industries can choose locations based upon data laws and requirements for storing said industry data;
The distribution can be scaled up or down as per client requirements;
If the user does not choose a location, the system can automatically choose a location for said user, dependent on the user's IP address or other electronic documentation, to a location nearest the user. The user may choose that location as being optimal, or disregard and choose his or her own desired locations.

Thus the scope should be determined by the appended claims and their legal equivalents, and not by the examples given.

What is claimed is:

1. A method of cloud or distributed storage environment: wherein at least at one user can choose at least one computing system, such as a desktop, server, or other electronic device, to manage data, locations, application or other computer-related tasks, wherein the environment is deployed on at least one local or remote geographic location, or combination thereof, of the user's choice or chosen by the system, dependent on the user's relative geographic location; and the environment may be accessed by any capable device.

2. The method of claim 1 wherein computer-related tasks may include data backups, data storage, remote desktop, application deployment, file manipulation, or other related tasks.

3. The method of claim 2 wherein the user may move, copy, duplicate, delete, share, modify, download, upload or otherwise manage files between locations, servers, other users, or any combination thereof, that the user has chosen.

4. The method of claim 1 wherein the user can deploy at least one instance of said environment, and scale the necessary resources higher or lower seamlessly, depending on the user needs.

5. The method of claim 4 wherein the necessary resources may include additional storage space, bandwidth, locations, servers, or combination thereof.

6. The method of claim 1 wherein the system can choose the geographic location closest to the user, using methods such as IP address, and other electronic tracking tools, for the purpose of choosing said location, generally near the user's location.

7. The method of claim 6 wherein the user may choose or disregard the server location provided by the system.

8. The method of claim 1 wherein capable devices may be smart phones, electronic phones, tablet personal computers, computers, or any related device capable of accessing the data.
